(19) United States
(12) Patent Application Publication
(10) Pub. No.: US 2014/0055853 A1
(43) Pub. Date: Feb. 27, 2014

(54) OPEN TOP MICROFLUIDIC DEVICE FOR MULTIPLEXING

(71) Applicants: Alex David Corwin, Niskayuna, NY (US); Robert John Filkins, Niskayuna, NY (US); Kashan Ali Shaikh, Clifton Park, NY (US); Adriana Ines Larriera Moreno, Malta, NY (US)

(72) Inventors: Alex David Corwin, Niskayuna, NY (US); Robert John Filkins, Niskayuna, NY (US); Kashan Ali Shaikh, Clifton Park, NY (US); Adriana Ines Larriera Moreno, Malta, NY (US)

(73) Assignee: GENERAL ELECTRIC COMPANY, Schenectady, NY (US)

(21) Appl. No.: 13/595,175

(22) Filed: Aug. 27, 2012

(51) Int. Cl. B01L 3/00; G02B 21/26; G01N 21/13

(52) U.S. Cl. 359/391; 422/503; 422/63; 901/2

(57) ABSTRACT

An open top microfluidic device comprising a microfluidic slide carrier and one or more multiplexing stations is provided which allows sequential staining and imaging without the need for using or removing a coverslip on a mounted biological sample.

### BACKGROUND OF THE INVENTION

The invention relates generally to an open top microfluidic device for multiplex staining and imaging which provides a method of encapsulating a mounted biological sample to allow for sequential in situ multiplexing analysis of the sample based on the concept of dye cycling, without the need for coverslipping and de-coverslipping during the staining and imaging process.

For sequential in situ multiplexing analysis, a biological sample such as a tissue samples or tissue microarrays (TMA) need to be stained with multiple molecular probes to investigate protein expression or spatial distribution quantitatively or qualitatively. The staining process may be performed manually or using an automated slide stainer. In both methods coverslipping is performed to allow for imaging of the stained sample. And provides a means of protecting the mounted sample. Coverslipping is a time consuming operation and often a source of error related to slide-to-slide variation, manipulation of the sample, and leakage of excess mounting media. In cases where multiple staining protocols and imaging modalities are used, the coverslip may be removed between processes. For example running combinations of H&E (hematoxylin and eosin), FISH (Fluorescent in Situ Hybridization), or ISH (In Situ Hybridization) processes may require the sample to be exposed to reagents in between the various process steps. As such further variation in imaging may be seen as de-coverslipping in particular may result in tissue loss.

Thus, a need therefore exists for a more robust system that can address the needs of sequential in situ multiplexing analysis and imaging without the variations introduced by coverslipping process.

### BRIEF DESCRIPTION OF THE INVENTION

The present invention overcomes the aforementioned drawbacks by providing an open top microfluidic slide carrier which may allow sequential staining and imaging without the need for using or removing a coverslip.

According to one aspect of the present invention an open top microfluidic device is presented comprising a slide carrier and one or more multiplexing stations. The slide carrier comprises a base layer having at least one attachment point positioned on the top surface and at least one attachment point position on the bottom surface of the base layer, a frame adapted to attach to the base layer, at least one central opening defined by the frame body and having four sidewalls wherein the four sidewalls are capable of retaining a fluid in contact with the base layer and is further configured to overlay a portion of a mounted biological sample, positioned against the top surface of the base layer and to retain the tissue slide against the base layer in a horizontal position; and a clamping mechanism to align and attach the frame to the base layer via said attachment points. The multiplexing stations comprise at least one attachment point position to align with at least one of the attachment points of the bottom of the base layer, a reagent delivery device configured to deliver one or more reagents into the fluidic chamber, and a reagent removal device configured to remove one or more reagents out of the fluidic chamber.

In another embodiment, a heater may be positioned below the base layer and configured to apply heat to a tissue slide positioned within the slide carrier.

Various other features and advantages of the present invention will be made apparent from the following detailed description and the drawings.

### BRIEF DESCRIPTION OF THE DRAWINGS

The drawings illustrate an embodiment presently contemplated for carrying out the invention.

FIG. 1 is schematic diagram of one embodiment of an open top slide carrier; a cross sectional view (1a) and a top down view (1b). FIG. 1a depicts a cross section view, while FIG. 1b depicts a top down view of the slide carrier

FIG. 2 is an illustration example of a reagent delivery device, wherein a reagent is added by a capillary device through the chamber opening.

FIG. 3 is an illustrated example of a reagent delivery device configured as a plug cover (310) for press fitting in to the central opening of the frame.

FIG. 4 is illustrated examples of reagent removal device may be configured as an aspirator (4a) and as a trough or channel to allow reagents to flow across the surface of the biological sample (4b).

FIG. 5 is an illustrated example of two multiplexing station configured for deparaffinization (dewaxing) and washing whereby a sample may be moved between two stations (station 1 and station 2).

FIG. 6, in certain embodiments, the imaging station may be further configured with a retractable plunger (610) designed to control the position and geometry of an immersion fluid (620).

FIG. 7 is a process flowchart of one embodiment of a sequential method of staining and imaging.

FIG. 8 depicts graphical representation of one embodiment of a sequential method of staining and imaging using three slide carriers.

FIG. 9 shows micrographs of a tissue sample undergoing DAPI stain and background Image on IN Cell using one embodiment of the slide carrier.

FIG. 10 shows micrographs of the tissue sample undergoing stain and imaging on IN Cell with two mounting media types (round 1 multiplexing) and using one embodiment of the slide carrier.

FIG. 11 shows micrographs of the tissue sample undergoing a bleach process and imaging on IN Cell using which resulted in deactivation of dyes through the bleaching process using one embodiment of the slide carrier.

FIG. 12 shows micrographs of a second round of multiplexing and imaging on IN Cell with 50% glycerol mm using one embodiment of the slide carrier.

FIG. 13 shows micrographs of a second round of multiplexing using an optional lifter slide with one embodiment of the slide carrier.

### DETAILED DESCRIPTION OF THE INVENTION

To more clearly and concisely describe and point out the subject matter of the claimed invention, the following definitions are provide for specific terms, which are used in the following description and the appended claims.

The singular forms “a” “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. Unless otherwise indicated, all numbers expressing quantities of ingredients, properties such as molecular weight, reaction conditions, so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least each numerical parameter should at least be construed in light of the number of reported significant digits and by applying ordinary rounding techniques

As used herein, the term “biological sample” refers to a sample obtained from a biological subject, including sample of biological tissue or fluid origin obtained in vivo or in vitro. Such samples may be, but are not limited to, tissues, fractions, and cells isolated from mammals including, humans. The biological sample may be mounted or fixed onto a solid support for example a tissue section fixed to a microscope slide, or a tissue micro array.

In certain embodiments, the open top microfluidic slide carrier provides a means of containing and positioning a mounted biological sample, so that it can sequentially be: stained with a dye, imaged with any high resolution microscope or fluorescent reporter, bleached or quenched, then the cycle repeated without requiring the sample be protected with a coverslip. As traditionally used, a coverslip covers mounted sample as a way to protect both the sample and the microscope objective and to introduce optical correction consistent with a microscope objective requirements.

As such, in certain embodiments, the slide carrier is designed to enable all aspects of tissue preparation, staining, imaging, and bleaching to occur without the need to apply a coverslip to the slide. The slide carrier is designed for easy transport by simple robotics to move it between a staining station and an imaging station. Furthermore, the open design of the carrier allows imaging from either below the sample, through an optical port or aperture in the base, for example through glass, or above the sample via an immersion fluid applied and the use of an immersion objective lens objective, or through a temporary lifter slip which does not come in contact with the surface of the tissue sample.

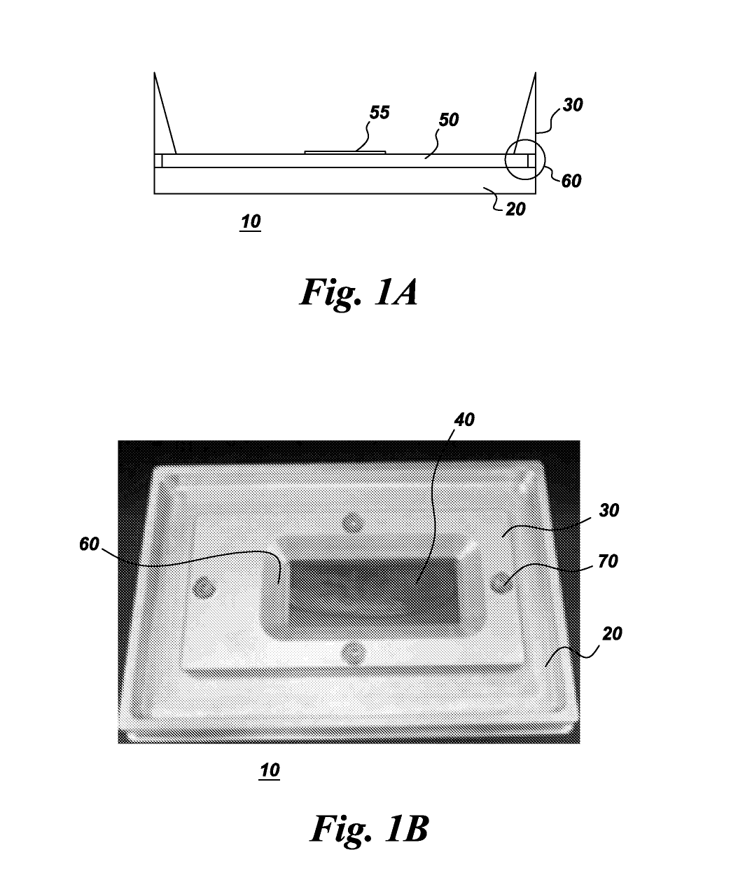

FIG. 1 depicts one embodiment of the invention wherein the open top slide carrier (10) consists of a base holder (20), a frame (30) having at least one central opening (40), and a clamping mechanism (70). The slide holder is configured such that a slide (50), with a mounted biological sample (55) maybe placed on the base with the biological sample facing up. The frame (30) is placed over the slide (40) such that the frame overlays a portion of the slide to position it against the base layer such that the frame's central cavity exposes the biological sample. In certain embodiments, to provide unbroken contact between the surface of the base holder and the frame, the frame may have a lip or indented surface (60) to allow for overlaying of the slide. FIG. 1a depicts a cross section view, while FIG. 1b depicts a top down view of the slide carrier.

The side walls of the frame's central opening and the base layer creates an open top fluidic chamber around the slide in such a manner to allow reagents to be dispensed above the slide. As long as the slide is held in an upright or semi-upright orientation, the walls around the slide will prevent reagent from running out or leaking from the slide carrier. In certain embodiments the fluidic chamber has a volume capacity in the range of 1 μL to 1000 μL. While in other embodiments, the fluidic chamber has a volume capacity in the range of 25 μL to 250 μL.

As shown further in FIG. 1b, the base layer and the frame are attached by a clamping mechanism (70). For alignment of the base layer and the frame, the base layer has at least one attachment point positioned on the top surface which corresponds to at least one attachment point on the frame. The attachment points may be through holes or fitted inserts such that the clamping mechanism (70) provides proper alignment in addition to attaching the two parts. The clamping mechanism may be, but is not limited to, a fastener, clamp, or a male-female bolt. While not shown a gasket may optionally be positioned between the base holder and frame to provide a fluid tight seal.

The slide carrier forms an open top microfluidic flow chamber around the mounted sample. The height of the sample carrier may be determined based on the mounted sample and the volume of reagent to be applied. For example, where the sample is a tissue section, on a microscope slide having the internal cavity may have a dimension of approximately 55 mm by 20 mm and an internal chamber volume or holding capacity of the chamber in the range of 10 μL to 1000 μL, preferably, 50 μL to 200 μL determined by the carrier's dimensions.

In certain embodiments, the frame may have more than one opening. In such a configuration, multiple mounted biological samples may be place on the base and covered with the frame in a manner to create a fluid chamber around each individual sample for multiplexing and imaging.

As such, in certain embodiments, the slide carrier may be used for multiplexed tissue staining and imaging as described in U.S. Pat. No. 7,629,125 and U.S. Pat. No. 7,741,046.

The slide carrier provides a means of holding and positioning the biological sample mounted on slide. The slide may be configured similar to a standard glass pathology slide allowing the sample to be moved between multiplexing stations wherein the various process steps associated with multiplexing may occur. For example one multiplexing stations may be configured wherein individual stations are arranged to provide for one or more method steps in the process or arranged such that each station is configured for a single step. The steps include, but are not limited to, deparaffinization, multiplex staining step including, an antigen retrieval step, an incubation step, and dye bleaching, and an imaging step. Each step may be repeated, and depending on the protocol or need be repeated, performed in different order, or be excluded. In each case the stations are configured maintain control of spatial location and integrity of the sample.

In certain embodiments, the multiplexing station has an attachment point that corresponds to an attachment point on the base layer (20) of the slide carrier. In this manner the slide carrier may be positioned and temporarily fixed onto the multiplexing station. The slide carrier is configured to be transported from one multiplexing station to another; as such transport points or guides may be designed into the base layer or frame. In certain embodiments, a robotic device may be configured to engage with the slide carrier to transfer between stations and to control the position of the slide carrier on, or relative to, the one or more multiplexing staining station.

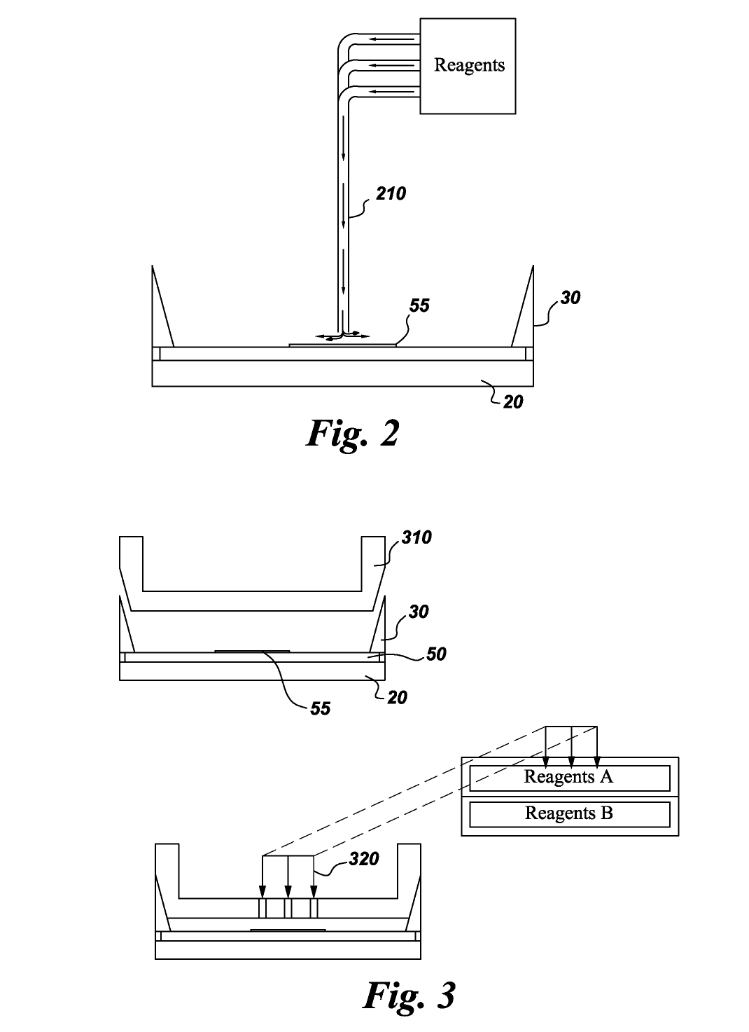

Multiplexing reagents may be dispersed from a dispenser in fluid communication with the slide carrier via a reagent deliver device. In other embodiments, one or more reagents may be dispensed directly into the open chamber using a device that comprises capillary tubing or pipetting action. Such a configuration is shown in FIG. 2 wherein one or more reagents are added by a capillary device (210) through the chamber opening.

In still other embodiments, FIG. 3, the delivery device may be configured as a plug cover (310) for press fitting in to the central opening of the frame. In certain embodiments, the reagents may be delivered through fluidic ports (320) in the plug cover. The plug cover may also serve to prevent evaporation of the reagents and to control the environment of the chamber during the process step. For example the plug cover may also be used to maintain humidity.

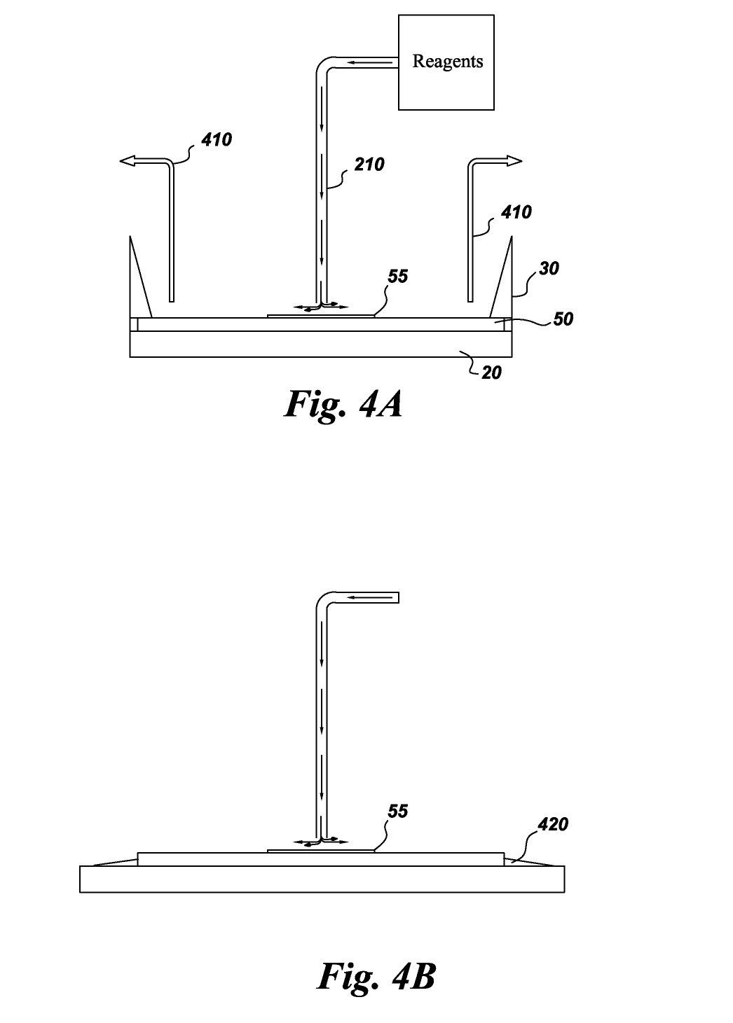

In certain embodiments, as shown in FIG. 4 the reagent removal device may be configured as an aspirator, such as capillary tubes 410, which draws reagents from the chamber. (FIG. 4a) In an alternative embodiments, as shown in FIG. 4, the removal device may be configured as a trough or channel configure wherein reagents flow across the surface of the biological sample and drain into the trough positioned (420) below the base (FIG. 4b). Drain hole leading to a reagent reservoir would assist in collecting the discarded reagents

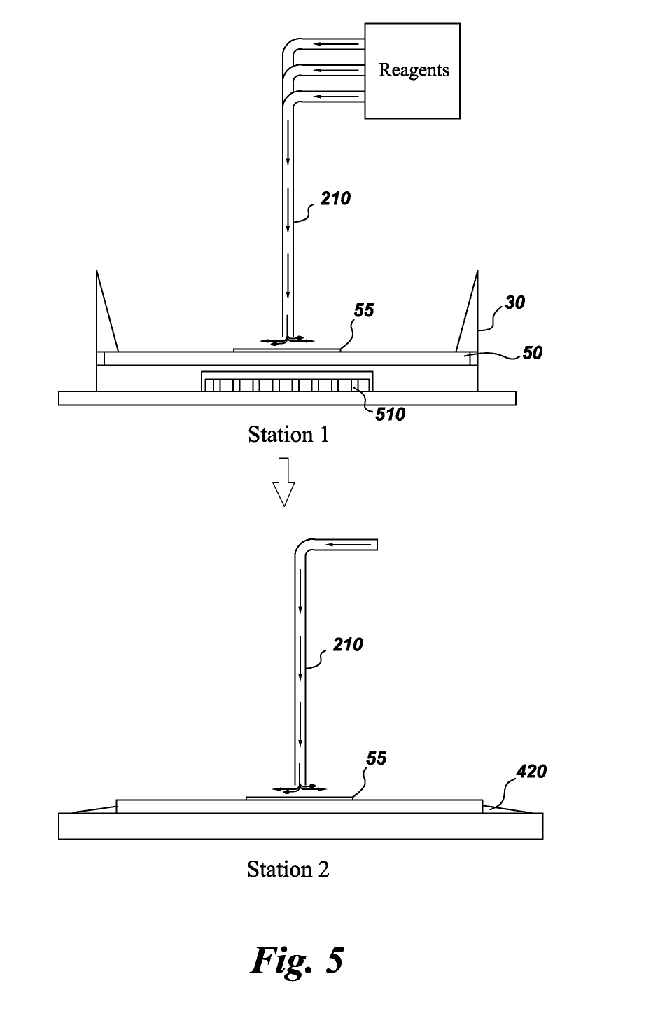

For example as shown in FIG. 5, two multiplexing station may be configured, one for deparaffinization (dewaxing) and one for removing the residual wax. As such, the tissue carrier may be positioned such that a dewaxing solution may be applied using the reservoir delivery device (210) such as a metered capillary tubes connected to one or more fluid reservoirs containing the solutions (station 1). The solution is delivered to the sample, and a predetermined concentration, temperature, and amount, wherein the open configuration allows the mounted biological sample to be bathed in the dewaxing solution. In certain embodiments gentle turbulence may be applied, however the preferred embodiments the solutions is added to the sample and a reagent removal device (410), such as one or more aspirator adjacent to the sample, removes the spent solution and residual wax. In certain embodiments, heat may be applied the tissue wherein the tissue carrier may be positioned over a heating pad (510) or element to convey heat. The sample may then be moved to a second station (station 2) wherein a reagent is added to remove the residual wax and deparaffinization reagents. In an alternative embodiment, both steps may be performed at one station.

Multiple dispensers may be used and connected to the slide carrier through a common port including configured including, but not limited to, a capillary type system or a plug cover type system. In certain molecular pathology application, reagents may be a specified panel of pre-packaged biomarkers for a particular test. The dispenser may also be designed to allow the addition of custom reagents by the user.

In certain embodiments, the slide carrier may further comprise a spring loaded top. The spring loaded top is configured in such a way that it may be opened during staining and closed during imaging to prevent imaging media evaporation.

In certain embodiments, a multiplexing station may be configured as an imaging device. In certain embodiments, the slide for mounting the biological sample is optically transparent in a specified range of wavelengths. The slide may be imaged in an inverted fashion by having the imaging device, such as a microscope objective, positioned below the slide. As such, optical analysis of materials/structures maybe accomplished by either epi-illumination or transmitted illumination, if both are transparent. In embodiment wherein the sample carrier may be used for multiplexed tissue staining and analysis, using transparent substrate and solid support will allows for both epi-fluorescence imaging and transmitted brightfield imaging. This enables analysis of fluorescence-based molecular pathology as well as conventional tissue analysis based on, for example, hematoxylin and eosin stain (H&E) chromogenic staining.

In other embodiments, the imaging station may be configures such that the sample can be imaged from the top either as the sole means of imaging or in combination with imaging in an inverted fashion as described above. In one such embodiment, imaging may be achieved by a fluid immersion objective to achieve high magnification and high numerical aperture. The fluid medium may include, but is not limited to water, glycerol, silicone oil, or mineral oil, or a combination thereof. Water immersion objectives are known to have slightly lower numerical aperture than comparable oil immersion lenses but enable high-resolution imaging. As such, the choice of fluidic medium and objective may vary based on the specific application.

In certain embodiments, the fluid medium may be a glycerol and water solution. The solution may be from approximately 50 to 95% aqueous glycerol solution. In certain embodiments the percentage of glycerol may be approximately 50-70%. In still other embodiments, other materials may be added to the solution. For example an anti-fade reagent may be added such as agent such as a 4% addition of 1,4-diazabicyclooctane (DABCO). For example an anti-fade reagent may be used such as an aqueous solution of 90% glycerol/4% DABCO. Other additives such as buffers or stabilizers may be used such as a phosphate buffered saline (PBS) as well as commercial products (Vectashield®, Vector Laboratories, Burlingame, Calif. and SlowFade® Life Technologies Co., Grand Island, N.Y.).

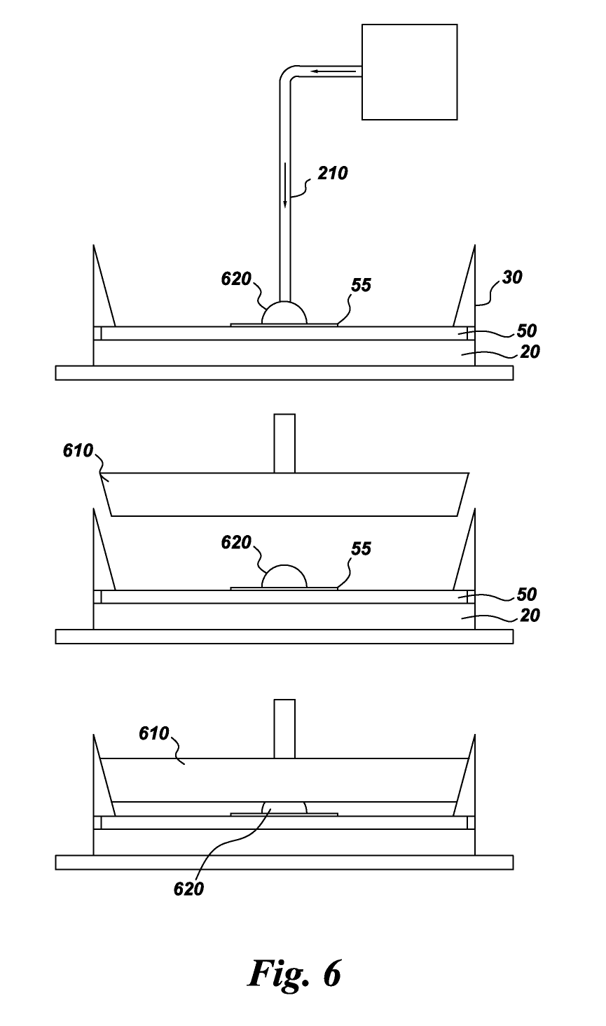

As shown in FIG. 6, in certain embodiments, the imaging station may be further configured with a retractable plunger (610) designed to control the position and geometry of an immersion fluid (620) applied to the surface of a tissue sample mounted in the slide carrier.

In certain embodiments, the slide carrier may be used with a robotically coupled stainer and imager. The slide carrier may, for example, fit in a standard micro-well plate footprint wherein the micro-well plate contains a biological sample. It may then be moved by robotics such, as a PAA Kinetix® robot (Rockwell Automation, Milwaukee Wis.) or similar device, between a staining station and an imaging station. As such, in certain embodiments, the robotic device configured to engage with the slide carrier and control the position of the slide carrier relative to the one or more multiplexing staining station.

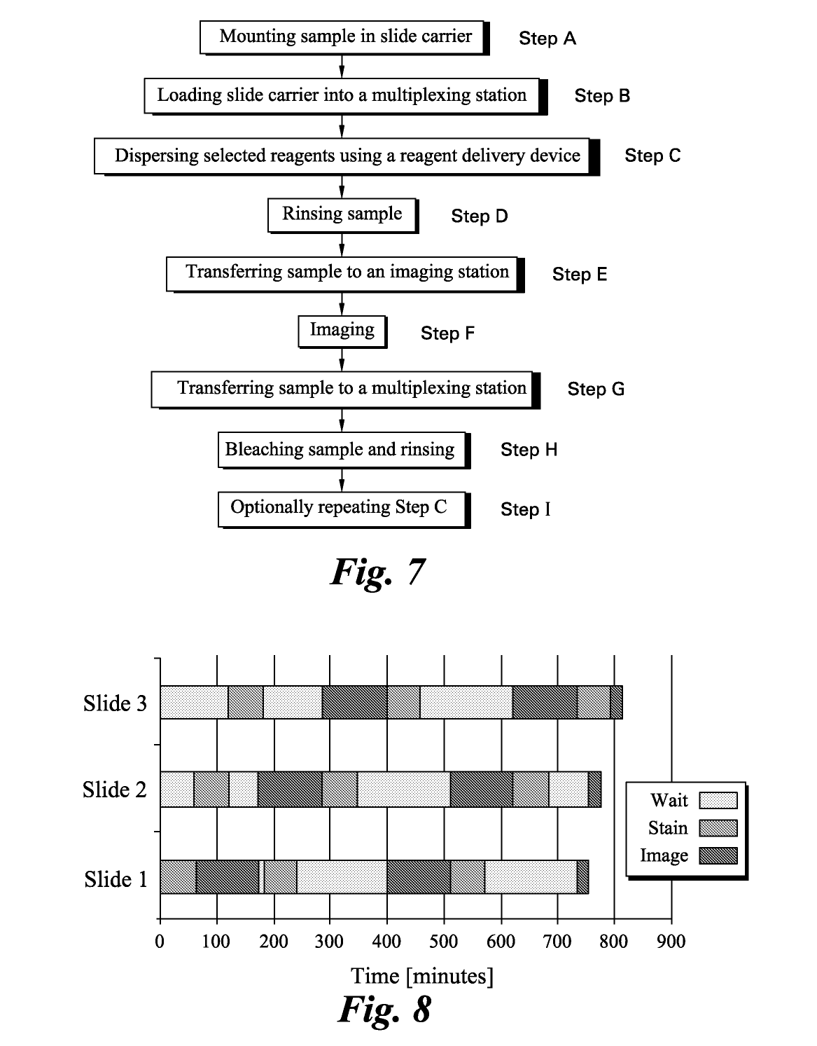

FIG. 7 shows a flowchart of one embodiment of a sequential method of staining and imaging. As shown the method involves loading the slide mounted with the sample into the slide carrier by placing the slide between the base holder and the clamp (step A). The carrier may then then be loaded into a multiplexing station (step B) for example a staining station, where selected reagents may be dispersed onto the sample by way of a reagent delivery device (step C). The sample may be rinsed (step D). Subsequently, the sample may be transferred by robotics to an imaging station such as a microscope (step E), for imaging (step F). After imaging, the slide may be returned to the staining apparatus (step G) where bleaching occurs to remove the stain signal (step H), which may include additional rinsing (step I). If desired new reagent may be dispersed onto the slide and the steps C through F, are repeated one or more times.

In certain embodiments, a lifter slip may also be used be used for incubation of the mounted biological sample on the slide. The lifter slip provides a raised edge design such that separation occurs between the sample and the lifter slip itself. The lifter slip is designed to be removed prior to imaging.

In certain operations the staging of two or more slide carriers would allow for an operation of staggered staining and imaging of multiple samples. This is shown in FIG. 8 which graphically depicts the staging of three slide carriers which would allow for an operation of staggered staining and imaging of multiple samples. The graph depicts a plot of an automated operation using three slide carriers for an increased throughput with one imaging station. Thus, as illustrated in certain operations the use of multiple slide carriers provides for an increased throughput.

### EXPERIMENTAL

A series of non-cover slip staining and imaging was performed using the steps outlined above to access quality of staining an imaging. A DAPI stain was applied to the fluid chamber and background image obtained using glycerol and an immersion lens. The sample ((Pantomics, Inc. TMA MTU 541 (Richmond, Calif.)) was then prepared for direct conjugation in an incubation chamber and reimaged using glycerol and an immersion lens.

Step 1: Deparaffinization: A standard deparaffinization process was used involving slide clearing and dehydration protocol using xylene, ethanol, and water. After dewaxing, no paraffin or visual residue was observed on the slide and the sample was used for the subsequent multiplexing steps.

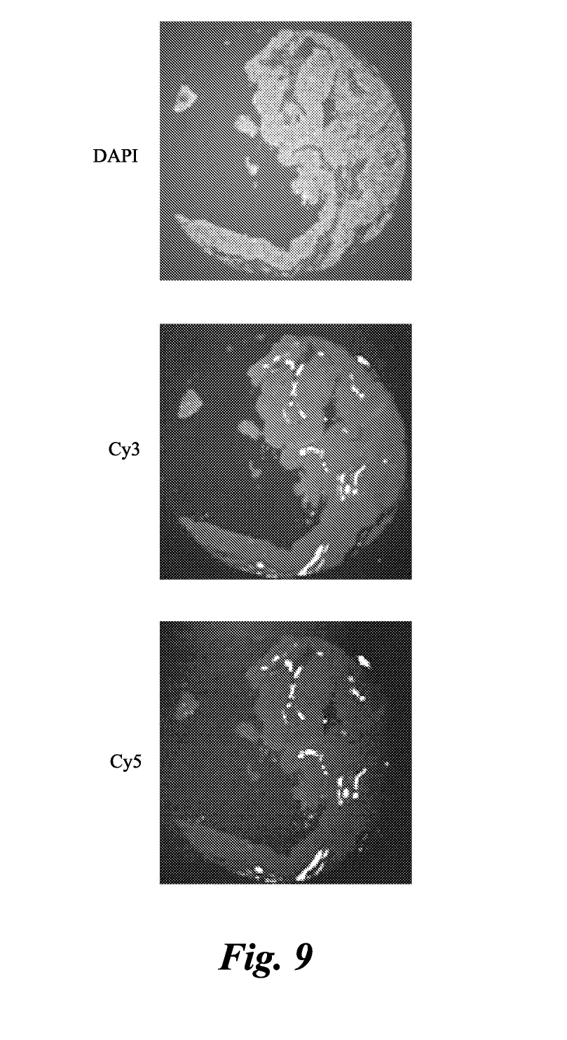

Step 2: DAPI stain and Background Image: DAPI was applied for 15 minutes on a biological sample mounted in the slide holder, washed with PBS (2 ml) for 5 minutes, and a back ground image obtained on IN Cell® device (GE Healthcare, Grandview Blvd. Waukesha, Wis.) (DAPI, Cy3, Cy5, FITC) @ 10× using 90% glycerol mounting media (volume 2 mL). The 10× images are shown in FIG. 9. Low background was obtained and quality staining occurred.

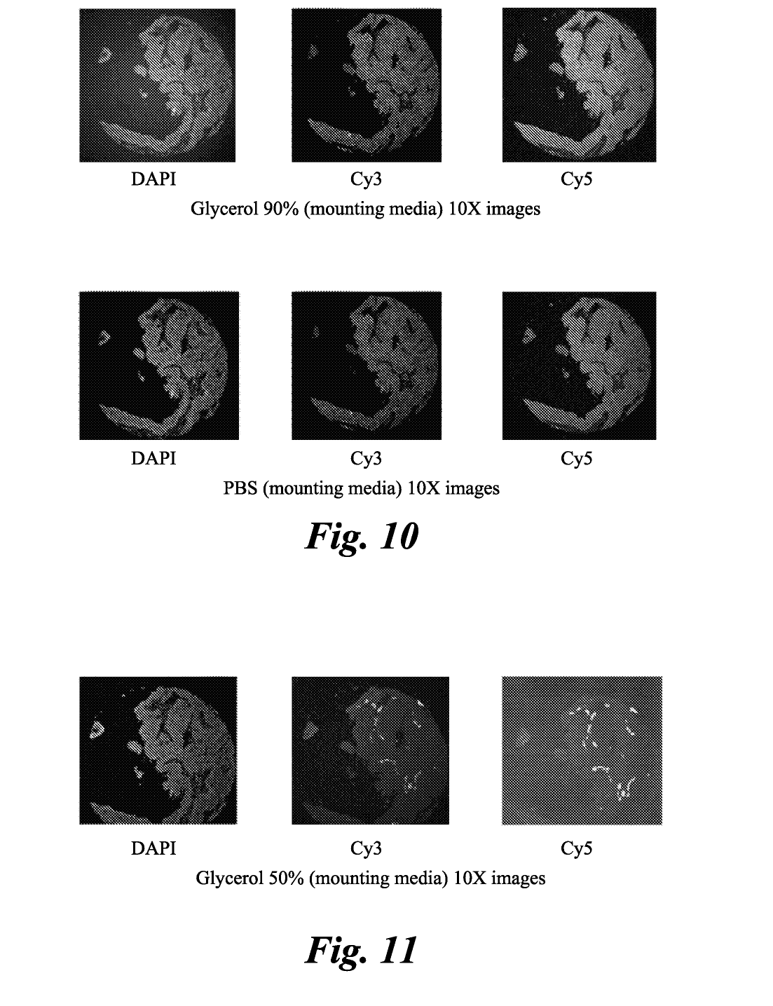

Step 3: Stain and Image on IN Cell with two mounting media types (round 1 multiplexing; Staining was performed using direct Conjugates: Cy 3 (PCK 26); Cy 5 (PCAD) and the sample incubate 1 hour (volume 500 uL). Images where obtained on IN Cell (DAPI, Cy3, Cy5) @ 10× with 2 types of mounting media-90% glycerol mounting media and PBS as mounting media. The 10× images are shown in FIG. 10 having good image quality with both imaging fluids.

Step 4: Bleach process and Image on IN Cell; Deactivation of dyes through bleaching process: 15 min incubation followed by a wash with PBS (volume 2 mL). The sample was re-stained with DAPI (5 min incubation). Images were obtained on IN Cell (DAPI, Cy3, Cy5) @ 10× with 50% glycerol mounting media. The images are shown in FIG. 11 wherein bleaching resulted in deactivation of the stains.

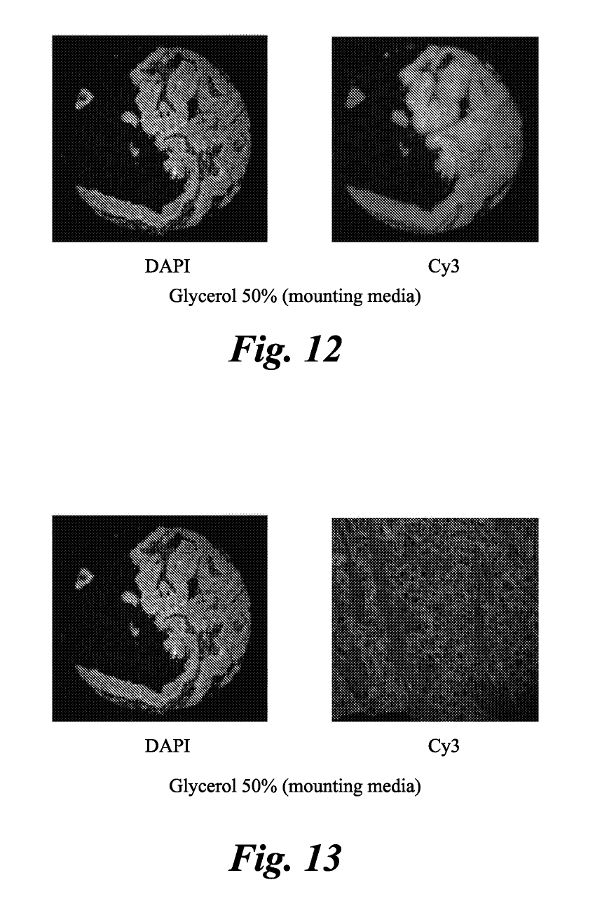

Step 5: Stain and Image on IN Cell with 50% glycerol mm (round 2 multiplexing); the sample was re-stained using direct conjugates Cy 3 (Na,K-Atpase) and incubated for 1 hour (volume 500 uL). Images were obtained on IN Cell at 10× with 50% glycerol mounting media. The images are shown in FIG. 12.

Step 5: Stain while using an optional LifterSlip™ (Erie Scientific Company. Portsmouth, N.H.) for Incubation step (round 2 multiplexing) Similar to step 4 above, after staining a lifter slip was added prior to incubation of the sample, the lifter slip did not come into contact with the sample and was removed prior to imaging. Images obtained on an Olympus® microscope @ 20× (Olympus America Inc., Center Valley, Pa.) with 50% glycerol mounting media. Images are shown in FIG. 13.

The present invention has been described in terms of the preferred embodiment, and it is recognized that equivalents, alternatives, and modifications, aside from those expressly stated, are possible and within the scope of the appending claims.

What is claimed is:

1. An open top microfluidic device comprising:
a slide carrier said slide carrier comprising;
a base layer comprising at least one attachment point positioned on the top surface and at least one attachment point position on the bottom surface of said base layer;
a frame adapted to attach to the base layer comprising;
at least one attachment point positioned to align with at least one of the attachment points on the surface of the base layer;
at least one central opening defined by the frame body and having four sidewalls wherein the four sidewalls are capable of retaining a fluid in contact with the base layer and is further configured to overlay a portion of a mounted biological sample, positioned against the top surface of the base layer and to retain the tissue slide against the base layer in a horizontal position; and
a clamping mechanism to align and attach the frame to the base layer via said attachment points; and
wherein the central opening of the frame and base layer define a fluidic chamber and wherein the volume capacity of said fluidic chamber is defined by the central opening of the frame;
one or more multiplexing stations said multiplexing station comprising;
at least one attachment point position to align with at least one of the attachment points of the bottom of the base layer;
a reagent delivery device configured to deliver one or more reagents into the fluidic chamber;
a reagent removal device configured to remove one or more reagents out of the fluidic chamber; and
an optional heater positioned below the base layer and configured to apply heat to a tissue slide positioned within the slide carrier.

2. The device of claim 1 wherein the fluidic chamber has a volume capacity in the range of 1 μL to 1000 μL.

3. The device of claim 2 wherein the fluidic chamber has a volume capacity in the range of 25 μL to 250 μL.

4. The device of claim 1 wherein the base layer and frame attachment points are through holes or fitted inserts and the clamping mechanism is a fastener positioned through the attachment points.

5. The device of claim 1 wherein the base layer comprises a viewing window comprising a transparent material and wherein the transparent material is configured to function as an aperture for imaging of a mounted biological sample within the slide carrier using an inverted microscope.

6. The device of claim 1 wherein the four sidewalls of the central opening are slanted inward to facilitate fluidic transfer.

7. The device of claim 4 wherein the slide carrier further comprises a gasket layer positioned between the periphery of the base layer and the frame.

8. The device of claim 1 wherein the slide carrier further comprises a spring loaded top positioned over the central opening of the frame such that the top does not contact a mounted biological sample in the slide carrier.

9. The device of claim 1 wherein the reagent delivery device is configured as a plug cover for press-fitting into the central opening of the frame and wherein reagents are delivered through openings in the plug cover.

10. The device of claim 1 wherein at least one of the multiplexing stations function is a dewaxing station configured to remove paraffin from a paraffinated mounted biological sample in the slide carrier.

11. The device of claim 1 wherein at least one of the multiplexing stations functions as a staining station configured to allow sequential staining of a mounted biological sample in the slide carrier.

12. The device of claim 1 wherein the at least one of the multiplexing stations is an imaging station configured to image mounted biological sample in a slide carrier.

13. The device of claim 12 wherein the imaging station further comprises an imaging device, said device comprising an inverted microscope, a fluid immersion microscope, or a combination thereof.

14. The device of claim 13 wherein the attachment points the bottom surface of the base carrier and configured to align the slide carrier with an objective lens of the imaging device.

15. The device of claim 13 wherein the imaging station further comprises a retractable plunger configured to control the position and geometry of an immersion fluid applied to the surface of a mounted biological sample in the slide carrier.

16. The device of claim 1 wherein the one or more multiplexing stations are configured to allow transport of the slide carrier between each station.

17. The device of claim 16 further comprising a robotic device configured to engage with the slide carrier and control the position of the slide carrier relative to the one or more multiplexing staining station.
